(19) United States
(12) Patent Application Publication
(10) Pub. No.: US 2026/0287529 A1
(43) Pub. Date: Sep. 24, 2026

(54) RELIABLE NON-DESTRUCTIVE DETERMINATION OF SAMPLE PARAMETER VALUES

(71) Applicant: SPECS Surface Nano Analysis GmbH, Berlin (DE)

(72) Inventors: Martin BREITSCHAFT, Berlin (DE); Paul DIETRICH, Berlin (DE); Marvin LINDNER, Berlin (DE); Sven MAEHL, Berlin (DE)

(21) Appl. No.: 18/862,420

(22) PCT Filed: May 1, 2023
(86) PCT No.: PCT/DE2023/100313

§ 371 Date: Nov. 1, 2024

(30) Foreign Application Priority Data
May 2, 2022 (DE) 10 2022 110 775.2

(51) Int. Cl. G01N 23/2273

(52) U.S. Cl. CPC G01N 23/2273; G01N 2223/3037

(57) ABSTRACT

The invention relates to a photoelectron spectrometer (100) comprising a sample value determining module (50) and to a method for determining the value of at least one of n sample parameters at a measuring point (22) of a sample (20) on the basis of photoemission measurements without having to destroy the sample (20) during the photoemission measurements. Values for at least one and up to n-1 sample parameters are obtained from the quantity of n sample parameters at the measuring point (22) of the sample (20) and multiple photoemission spectra from the measuring point (22) of the sample (20), said photoemission spectra being captured using different levels of excitation energy. The value of the at least one sample parameter at the measuring point (22) of the sample (20) is determined on the basis of the values of the up to n-1 sample parameters and the photoemission spectra.

### FIELD OF THE INVENTION

The invention relates to a measurement method for determining a value of at least one of n sample parameters at a measuring point of a sample based on photoemission measurements without destroying the sample during the photoemission measurements. Furthermore, the invention relates to a sample parameter value determination module, to a photoelectron spectrometer comprising the sample parameter value determination module, to a corresponding computer program product and to a computer-readable medium comprising the computer program product.

### PRIOR ART

A measurement method is known from Y. Hoshina et al. “Non-destructive depth profile evaluation of multi-layer thin film stack using simultaneous analysis of data from multiple X-ray photoelectron spectroscopy instruments,” 2022 Jpn. J. Appl. Phys. 61 046501, in which photoemission measurements are carried out on a sample using different excitation energies and different emission angles at different photoelectron spectrometers in order to characterize the sample and in particular to determine a depth profile for the sample without destroying the sample.

EP 2 542 035 B1 discloses a photoelectron spectrometer that can irradiate a sample with two different excitation energies at one measuring point.

### DESCRIPTION OF THE INVENTION

One object of the invention can be considered to be providing a measurement method, a sample parameter value determination module, a photoelectron spectrometer, a computer program product and a computer-readable medium which allow an improved or more reliable non-destructive determination of sample parameter values.

According to a first aspect of the invention, a measurement method is provided for determining a value of at least one of n sample parameters at a measuring point of a sample based on photoemission measurements without destroying the sample during the photoemission measurements. The method comprises the following steps:
obtaining values for at least one and up to n-1 sample parameters from the set of n sample parameters at the measuring point of the sample,
obtaining a plurality of photoemission spectra captured with different excitation energies from the measuring point of the sample,
determining the value of the at least one sample parameter at the measuring point of the sample based on the up to n-1 sample parameters and the photoemission spectra.

The inventors have recognized that it is not reliably possible to use a photoemission spectrum as the basis for a full characterization of a sample, in particular the preparation of a depth profile of the sample comprising information about the layer structure containing the chemical composition as well as the layer thicknesses, depending on the number of unknown sample parameters, in particular for a depth profile analysis. In particular, more complex layer structures with a plurality of layers of different thicknesses comprising different depth profiles can comprise similar photoemission spectra.

The method according to the invention allows the value of one or more sample parameters to be reliably determined, such as layer thicknesses, chemical compositions of layers, homogeneity of the layers and chemical states of materials in the layers, such as oxidation states, or the like, based on a plurality of photoemission measurements.

Preferably, the sample is a solid sample comprising one or more layers. The sample can, for example, be a silicon (Si) wafer with a layer sequence deposited thereon. The sample may also contain a layer structure comprising solid, liquid and/or gaseous layers. The sample may also comprise a different sample structure. For example, different materials can be arranged in different regions on an identical horizontal plane of the sample structure. Additional layers, such as contamination layers or layers that do not affect the function of the sample, can be arranged on the sample. Instead of a complete layer, an additional region, for example a contamination region, that does not form a complete layer can be arranged on the surface of the sample. The additional layers do not form part of the sample within the context of the invention. For example, a contamination layer can be created by the deposition of dust or dirt on a surface of the sample. Such a contamination layer in principle does not form part of the sample. However, a contamination layer on the sample can be part of the sample if, from the user's point of view, it is intended to form part of the sample, e.g. due to the contamination layer possibly affecting the sample properties to be measured. The contamination layer can be formed, for example, by oxidation or deposition of dust or dirt on the surface. The method may be configured to take into account the contamination layer, for example formed by a carbon layer or carbon-containing layer.

Alternatively, the method may include cleaning the surface of the sample and/or preparing the surface in a vacuum system such that the surface of the sample has a reduced contamination layer thickness or does not comprise the contamination layer. In order to clean the surface of the sample, for example, the contamination layer may be irradiated or the sample may be sputtered.

Within the meaning of the patent, the sample is not destroyed if it is not changed compared to its state before a photoemission measurement, except for changes caused by the photoemission measurement. The photoemission measurement consists of irradiating the sample with radiation of a certain wavelength and receiving photoelectrons emitted by the sample using a detector, resolved by kinetic energies. For example, within the meaning of the patent, the sample is destroyed if layers of the sample are contaminated by foreign atoms or if layers are removed. Removing the contamination layer, for example when cleaning during sample preparation, is not considered to be destroying the sample. Within the meaning of the patent, the sample is not destroyed by cleaning the sample, since the contamination layer is not part of the sample to be measured. In order not to destroy the sample during cleaning by sputtering with ions, for example, it may be provided that it is ensured that the ions not penetrate into the sample to be measured. The contamination layer can also be taken into account, for example as part of the sample, by means of sample parameters.

The photoemission spectra can be provided by a photoelectron spectrometer with a plurality of wavelengths. For example, the photoelectron spectrometer can comprise a monochromator for different wavelengths. The different wavelengths correspond to different excitation energies. This allows radiation with different excitation energies to be generated in a photoelectron spectrometer.

The sample parameters can include sample structure parameters and sample material parameters. The sample structure parameters may include, for example, the sample structure, the layer structure, chemical compositions of layers of the sample, chemical compositions of regions of the sample, materials present in each of the layers of the sample, layer thicknesses t or the like. The layer structure of the sample can, for example, contain information about the chemical composition of layers in the sample and their thicknesses. The materials in the sample can, for example, be described by a molecular formula. Alternatively, for example, the concentrations of the materials can be given depending on a position in the sample. For example, the concentration can be given depending on a horizontal and a vertical position of the material in the sample relative to a reference point. For the vertical position, for example, a surface oriented in the direction of the incident radiation can be used as a reference surface and a depth can be used as the relative distance from the reference surface in order to determine the vertical position.

The sample material parameters can be, for example, the total photoionization cross-section o, the asymmetry parameter β, the extinction length λ(Eₖᵢₙ) that is dependent on a kinetic energy of photoelectrons, binding energies E_{b}, mass densities, particle densities, band gaps, atomic numbers, or the like.

The at least one sample parameter whose value is to be determined can describe part of a sample structure, in particular a layer structure, at the measuring point of the sample. This enables reliable depth profiling of the sample at one measuring point. The sample structure of the sample can indicate a concentration of the chemical elements depending on the depth. The at least one sample parameter can be, for example, a concentration of a chemical element based on the depth or a thickness of a layer of the sample. For example, a plurality of sample parameters can also represent a layer structure of the sample; for example, the sample parameters can represent the chemical compositions of the layers of the sample. The chemical compositions of the layers of the sample can, for example, represent mixtures of chemical elements in the different layers and their arrangement in the sample.

Determining the value for the at least one sample parameter may comprise at least one of the steps of:
determining peak areas in each of the photoemission spectra,
determining a background in each of the photoemission spectra, and one of the steps of:
determining the value for the at least one sample parameter based on the peak areas of the photoemission spectra,
determining the value for the at least one sample parameter based on the backgrounds of the photoemission spectra, and
determining the value for the at least one sample parameter based on the peak areas and the backgrounds of the photoemission spectra.

A peak corresponds to a spike in a photoemission spectrum. The peak area is the area under the peak curve reduced by a background. The background can be determined, for example, based on different background models, e.g. based on different inelastic scattering models for the photoelectrons.

The background is created by photoelectrons that are non-primarily emitted, for example inelastically scattered photoelectrons in the sample, and can be determined using background models. The background can be determined using the same or a background model different from the background model used to determine the peak areas.

Determining the value for the at least one sample parameter based on the backgrounds or the peak areas and the backgrounds allows a more reliable determination of the value, since additional information can be obtained from the spectra.

The surface of the sample oriented in the direction of the incident radiation, through which surface radiation is passed in order to generate photoelectrons during photoemission measurement, can be smooth, rough or structured. Furthermore, surfaces between adjacent layers of the sample can also be smooth, rough or structured. The method for determining the value for the at least one sample parameter may take into account the type of surface of the sample oriented in the direction of the incident radiation and the type of surfaces between adjacent layers of the sample. For example, for a rough or structured surface, the structure or roughness can also be taken into account. Obtaining the values for the at least one and up to n-1 sample parameters may include one or more of the steps of:
entering a respective value for one or more of the sample parameters by a user,
measuring a respective value for one or more of the sample parameters using another measurement method,
selecting or reading a respective value for one or more of the sample parameters from a sample parameter database comprising predetermined values for the sample parameters.

The other measurement methods can include, for example, optical methods, such as ellipsometry measurement methods. Depending on which other measurement method is used, values for different sample parameters can be obtained. It is also possible to combine the different method steps for obtaining the values for the up to n-1 sample parameters in order to obtain one value for each type of sample parameter. For example, the user can enter the value for one or more of the sample parameters and, based on this value or on these values for the sample parameters, values for other sample parameters can be selected or read from the sample parameter database. For example, the user can enter the chemical composition of the sample structure, and the material parameters of the materials, especially for their chemical elements in the sample structure, can be selected or read from the sample parameter database. In the sample parameter database, sample parameter values can be associated with other sample parameter values, such as chemical elements with specific binding energies of the different orbitals of the chemical element. By obtaining the values for the sample parameters, the value of the at least one sample parameter can be determined more reliably. The greater the number of values obtained for the n-1 sample parameters, the more reliably the value for the at least one sample parameter can be determined.

In the sample parameter database, predetermined values for the sample parameters can be assigned, for example, to certain photoemission spectra and/or values of parameters derived from the obtained plurality of photoemission spectra captured with different excitation energies, such as energy positions of peaks, relative depths or the like. The sample parameter database can be generated, for example, by collecting and correspondingly assigning known values for sample parameters to photoemission spectra and/or values for parameters derived from photoemission spectra. Reading or selecting a respective value for the one or more sample parameters from the sample parameter database may comprise a step of:
comparing the photoemission spectra in the sample parameter database and/or the values for the parameters derived from the obtained plurality of photoemission spectra captured with different excitation energies with the obtained plurality of photoemission spectra captured with different excitation energies and/or values for derived parameters, and reading or selecting the respective value for the one or more sample parameters associated with the closest matching photoemission spectra or the closest matching values from the derived parameters of the sample parameter database.

The method may also provide for obtaining the value for one or more sample parameters before comparing the photoemission spectra included in the sample parameter database and/or the values for the derived parameters with the obtained plurality of photoemission spectra captured with different excitation energies and/or the values for the derived parameters. This allows the search space for the possible photoemission spectra to be narrowed down. This may make finding the most suitable photoemission spectra and/or the most suitable values for the derived parameters faster and more reliable, since fewer photoemission spectra and/or values for derived parameters need to be compared. This improves the process of selecting or reading the respective value for the one or more sample parameters from the sample parameter database. For example, chemical elements present in the sample, e.g. silicon (Si), hafnium (Hf), oxygen (O), nickel (Ni), etc., can be entered by a user as sample parameters before further sample parameters are selected or read from the sample parameter database in a subsequent method step.

The sample parameter database may contain values for different sample parameters, such as known layer structures of samples, binding energies, mass densities, particle densities, total photoionization cross-sections, asymmetry parameters, band gaps, atomic numbers, or the like. This may allow a layer structure to be assigned to an unknown sample based on the obtained plurality of photoemission spectra captured with different excitation energies or the values for the derived parameters.

The method may provide proposing a layer structure. The user can confirm that the proposed layer structure is correct, or reject it. If the user rejects the proposed layer structure, a second most suitable layer structure can be proposed based on the photoemission spectra. Alternatively, the value for the at least one sample parameter can also be determined for a plurality of layer structures based on the up to n-1 sample parameters and the photoemission spectra. The most suitable layer structure, e.g. with the lowest chi square, can then be proposed as the layer structure. The layer structures can be arranged in a hierarchy depending on how suitable they are.

The plurality of photoemission spectra captured with different excitation energies may include photoemission spectra captured from the measuring point of the sample with different emission angles. The photoemission spectra may include photoemission spectra with the same excitation energy and different emission angles and/or photoemission spectra with the same emission angle and a different excitation energy. This allows more information to be obtained from the sample. The photoemission spectra with different emission angles can be captured by an angle-resolving photoelectron spectrometer. This allows fast and precise photoemission measurements without the need to vary the sample inclination. An angle-resolving photoelectron spectrometer is known, for example, from U.S. Pat. No. 6,104,029A. For example, in order to measure different sample emission angles, different electron trajectories can be selected by means of the angle-resolving photoelectron spectrometer. Alternatively, the sample inclination can be changed in order to measure a different emission angle.

The emission angles can span an interval of 60°. For example, the photoemission spectra can be captured in a 5° grid, for example with −30°, −25°, −20°, −15°, −10°, −5°, 0°, 5°, 10°, 15°, 20°, 25° and 30°. For example, photoemission spectra can be captured for 13 different angles between −30° and +30° with respect to an optical axis of a lens device of the photoelectron spectrometer. Alternatively, photoemission spectra with other irregular angular increments or with irregular angular distances can also be captured.

The measuring point of the sample can comprise an extension of 100 μm or less, preferably 10 μm or less. This allows a local value to be determined for the at least one sample parameter at the measuring point of the sample. The measuring point is not to be understood as a point in the mathematical sense here, but as a point with an extension that can comprise different shapes and sizes, for example depending on the focus of a beam for exciting photoelectrons from the sample. If the sample has different sample parameter values in the horizontal direction, different local values of the sample can be captured by moving the measuring point. For example, a sample can also be rasterized. This allows the value for the at least one sample parameter to be displayed quasi-continuously depending on the vertical position in the sample. This may, for example, allow concentration gradients to be determined in the horizontal direction.

The excitation energies can lie in the range between 1 keV and 10 keV. This allows different depths of the sample to be reached, for example between 5 nm and 30 nm. The use of the different excitation energies allows, on the one hand, information to be obtained from different depths and, on the other hand, different information from the same depth to be taken into account. At higher excitation energies, a greater depth in the sample can be achieved. In addition, information are, however, also obtained from shallower depths, which, combined with the information on the lower excitation energies for shallower depths, allows, for example, a more reliable statement to be made about the layer structure at shallower depths.

The different excitation energies can be generated, for example, by irradiating different anode materials with electrons from an electron gun. The excitation energies can be, for example, Al Kα with 1.49 keV, Ag Lα with 2.98 keV, Ag Lβ with 3.15 keV, Ti Kα with 4.51 keV, Cr Kα with 5.41 keV, Cu with 8.05 keV and Au with 9.71 keV. The excitation energies used to generate the photoemission spectra with different excitation energies can be selected to comprise a similar energy gap between one another. For example, the excitation energies 1.49 keV, 2.98 keV, 4.51 keV and 5.41 keV with gaps of between 0.9 keV and 1.53 keV can be chosen. This allows improving the amount of obtained information while taking into account the space limitations in a photoelectron spectrometer with a plurality of wavelengths.

The method may comprise the steps of:
providing a calibration sample for which values for a sample structure and a chemical composition are known, and
determining values for measurement method parameters in order to determine the value of the at least one sample parameter by means of the calibration sample.

A calibration sample or reference sample can, for example, be a sample whose structure and chemical composition are known, but on which additional layers can be arranged, such as a contamination layer. The contamination layer can, for example, be taken into account when determining the values for the measurement method parameters or can be removed by cleaning. For the calibration sample, values are known for a sufficient number of sample parameters, which allows the values for the measurement method parameters to be determined with sufficient accuracy or an acceptable level of error. Using a calibration sample allows the determination of measurement method parameters. This allows more reliable absolute and relative values to be ascertained for samples for which the value of at least one sample parameter is unknown. The method steps can be used to calibrate, for example, an absolute angle scale for angle-resolved photoemission spectra. The measurement method parameters can include, for example, transmission functions between the sample and a detector device of the photoelectron spectrometer, an angle calibration of an absolute angle of the photoelectron spectrometer, the geometry of the measurement, imaging properties of an analyzer, transmission properties of the analyzer, a ratio of photon fluxes of a radiation source for different excitation energies or another measurement method parameter. The geometry of the measurement may depend, for example, on the sample orientation to the inlet aperture of a lens device of the photoelectron spectrometer and a distance between the sample and the inlet aperture of the lens device of the photoelectron spectrometer. The imaging properties of the analyzer can, for example, contain a functional relationship between the raw data it generates and measured quantities, such as electron energy and direction in the analyzer's coordinate system. The transmission properties of the analyzer may, for example, include a measured photoelectric current in relation to an emitted photoelectric current depending on the energy and direction of the photoelectrons. For example, the ratio of the photon fluxes of the radiation source, e.g. of an X-ray source, for the different excitation energies can be at least partially attributed to the transmission properties of the photoelectron spectrometer, for example. For example, the measurement method parameters can be determined for the peak areas and backgrounds of the photoemission spectra in such a way that the expected peak areas and the expected backgrounds agree with each of the measured peak areas and measured backgrounds.

The method may comprise the step of:
determining the value for the at least one sample parameter additionally based on the measurement method parameters determined by means of the calibration sample.

This allows a more reliable determination of the value for the at least one sample parameter.

According to a further aspect of the invention, a sample parameter value determination module is provided for determining a value for at least one of n sample parameters at a measuring point of a sample based on photoemission measurements without destroying the sample during the photoemission measurements. The sample parameter value determination module comprises:
an interface for obtaining values for at least one and up to n-1 sample parameters from the set of n sample parameters at the measuring point of the sample and a plurality of photoemission spectra captured with different excitation energies from the measuring point of the sample, and
a processor for determining the value for the at least one sample parameter at the measuring point of the sample based on the values of the up to n-1 sample parameters and the photoemission spectra.

This allows reliable determination of the value for one or more sample parameters at the measuring point of the sample.

According to a further aspect of the invention, a photoelectron spectrometer is provided with a sample parameter value determination module according to claim 11 or an embodiment of the sample parameter value determination module for determining the value of the at least one of the n sample parameters at the measuring point of the sample based on the photoemission measurements without destroying the sample during the photoemission measurements. The photoelectron spectrometer comprises:
an illumination device for illuminating the sample at the measuring point with radiation of different wavelengths,
a detector device for measuring photoelectrons emitted by the sample, wherein the photoelectron spectrometer is configured to capture a plurality of photoemission spectra with different excitation energies from the measuring point of the sample and to provide them to the sample parameter value determination module, and
   wherein the sample parameter value determination module is configured to determine the value for the at least one sample parameter at the measuring point of the sample based on the up to n-1 sample parameters from the set of n sample parameters and the photoemission spectra obtained from the detector device.

The detector device can be configured to measure the photoelectrons emitted by the sample with angle resolution. The photoelectron spectrometer can be an angle-resolving photoelectron spectrometer. This allows the provision of a compact photoelectron spectrometer for reliably determining the value for the at least one of the n sample parameters at the measuring point of the sample based on the photoemission measurements.

The photoelectron spectrometer can comprise a hermetically sealable cavity, in particular a vacuum chamber, in which the illumination device and the detector device can be arranged. A negative pressure, in particular an ultra-high vacuum, can be generated in the cavity. The photoelectron spectrometer may comprise an ultra-high vacuum pump or be connected to an ultra-high vacuum pump to generate an ultra-high vacuum in the cavity, in particular in the vacuum chamber. Additionally or alternatively, the photoelectron spectrometer may comprise a vacuum pump or be connected to a vacuum pump to create a negative pressure in the cavity. The vacuum pump can be configured to generate a negative pressure in the cavity. The vacuum pump can, for example, be configured to generate an absolute pressure between 0.1 mbar and 600 mbar, between 0.1 mbar and 400 mbar, or between 1 mbar and 100 mbar, for example 20 mbar. This allows the generation of different pressures close to ambient pressure, in particular close to atmospheric pressure. The vacuum pump can, for example, be a diaphragm pump.

The illumination device can comprise a radiation source, for example a radiation source for electromagnetic radiation, such as X-rays, synchrotron radiation or deep ultraviolet (DUV) radiation. The illumination device can additionally comprise a monochromator for spectrally isolating a specific wavelength from an incident beam from the radiation source or for monochromatization. This allows the provision of radiation that can be used to irradiate the sample.

The illumination device can be movable and/or tiltable so that it can be moved toward the sample in order to irradiate the sample with the radiation. Alternatively or additionally, the detector device can be movable and/or tiltable such that it can be moved toward the sample in order to receive photoelectrons emitted from the sample. Alternatively or additionally, the sample can also be movable and/or tiltable, for example by means of a manipulator.

The detector device can comprise a front cap electrode, one or more electronic lenses, one or more deflectors, an analyzer and/or a detector. The detector system can, for example, be formed by the front cap electrode, the electronic lenses, the analyzer and the detector. The detector device can comprise one or more interconnected cavities forming an interior of the detector device through which photoelectrons emitted from the sample can be guided from the front cap electrode to the detector. In addition, the detector device can also include one or more deflectors to direct the photoelectrons to an input of the analyzer.

The front cap electrode can have a conical shape and an inlet opening which has a conical shape so that gas molecules entering the inlet opening can quickly disperse behind the inlet opening in the cavity enclosed by the front cap electrode. This enables a rapid pressure reduction. This can increase the free path length for electrons behind the inlet opening. This is useful, for example, when photoemission measurements are performed at pressures close to atmospheric pressure to ensure sufficiently high intensity.

Different negative pressures can prevail in the multiple interconnected cavities, which pressures can decrease further from the inlet opening towards the detector. For this purpose, different pressure reduction stages can be provided and the pressure can be reduced by different amounts, for example by means of pumps with different pumping strengths in the cavities arranged one after the other. This may allow a lower pressure to be maintained in the detector device, for example in the case of an absolute pressure between 0.1 mbar and 100 mbar, e.g. 25 mbar, in front of the front cap electrode, an absolute pressure in the range of 10⁻⁴ mbar to 10⁻² mbar, e.g. 10⁻³ mbar can be maintained in the cavity enclosed by the front cap electrode, an absolute pressure of 10⁻⁶ mbar to 10⁻⁴ mbar, e.g. 10⁻⁵ mbar can be maintained in a downstream cavity and an absolute pressure in the range of 10⁻⁸ mbar to 10⁻⁵ mbar, e.g. 10⁻⁶ mbar, can be maintained in the cavity upstream of the detector.

For example, the analyzer can be a hemispherical energy analyzer or the analyzer can comprise one of these. The detector can, for example, comprise an electron multiplier, a phosphor screen, a video camera, a CCD sensor (charge-coupled device) and/or a CMOS sensor (complementary metal-oxide-semiconductor). The detector can also be configured as a DLD (delay line detector).

According to a further aspect of the invention, the use of the method according to at least one of claims 1 to 10 or an embodiment of the method is provided for:
determining whether a layer of the sample has a predetermined thickness at the measuring point of the sample, and/or
determining a degree of diffusivity of a layer boundary between adjacent layers, and/or
determining an extent of a layer boundary between adjacent layers, and/or
determining a reproducibility of a process for producing the sample, and/or
testing an influence of the value of the at least one sample parameter on the function of the sample, and/or
comparing different samples, and/or
finding formulas for producing samples.

Determining whether a layer of the sample has a predetermined thickness at the measuring point of the sample allows improved quality control.

Determining a degree of diffusivity of a layer boundary between adjacent layers allows, for example, the determination of whether diffusion has occurred between the layers. For example, the layer boundaries can be sharp or fully diffuse. At a sharp layer boundary, materials from one layer meet materials from the other layer at the layer boundary without the materials of the layers extending across the layer boundary into the other layer each time. At a diffuse layer boundary, materials from one layer are also found beyond the layer boundary in the other layer, and vice versa. The degree of diffusivity depends on the proportion of materials that extends across the layer boundary. At a diffusivity of 0%, none of the materials in the different layers extend across the layer boundary. At a diffusivity F of 100%, the adjacent layers form a mixture where 50 vol. % of the materials of the adjacent layers are mixed at the layer boundary.

Determining an extent of a layer boundary between adjacent layers allows the verification of whether diffusion has occurred between the layers and how far material from one layer has diffused into the other layer.

Determining the reproducibility of a process for producing the sample allows improved quality control.

Testing an influence of the value for the at least one sample parameter on the function of the sample allows the optimization of sample structures for the function of a sample. Samples with different values for the at least one sample parameter can be prepared and, by comparing them, it is possible to determine how the change in the value affects the function of the sample. The measurement method allows the verification of whether the preparation of the sample has actually led to the desired value for the sample parameter. This can, for example, allow formulas for producing samples to be found and optimized.

According to a further aspect of the invention, a computer program product is provided, comprising instructions which, when the computer program product is executed by a processor, prompt the processor to carry out the method according to at least one of claims 1 to 10 or an embodiment of the method.

According to a further aspect, a computer-readable medium is provided on which the computer program product is stored.

The method according to claim 1, the sample parameter value determination module according to claim 11, the photoelectron spectrometer according to claim 12, the use according to claim 13, the computer program product according to claim 14 and the computer-readable medium according to claim 15 may comprise similar and/or identical preferred embodiments, as defined in particular in the dependent claims.

Furthermore, a preferred embodiment of the invention can also be any combination of the features of the dependent claims or the aforementioned embodiments in conjunction with the corresponding independent claim.

These and other aspects of the invention are explained in more detail below with reference to embodiments shown in the figures.

### BRIEF DESCRIPTION OF THE DRAWINGS

In the following figures:

FIG. 1 schematically and exemplarily shows an embodiment of a photoelectron spectrometer comprising a sample parameter value determination module for determining a value for at least one of n sample parameters at a measuring point of a sample based on photoemission measurements, without destroying the sample during the photoemission measurements;

FIG. 2 shows a flow chart of an embodiment of a method for determining a value for at least one of n sample parameters at a measuring point of a sample based on photoemission measurements without destroying the sample during the photoemission measurements.

### DESCRIPTION OF EMBODIMENTS

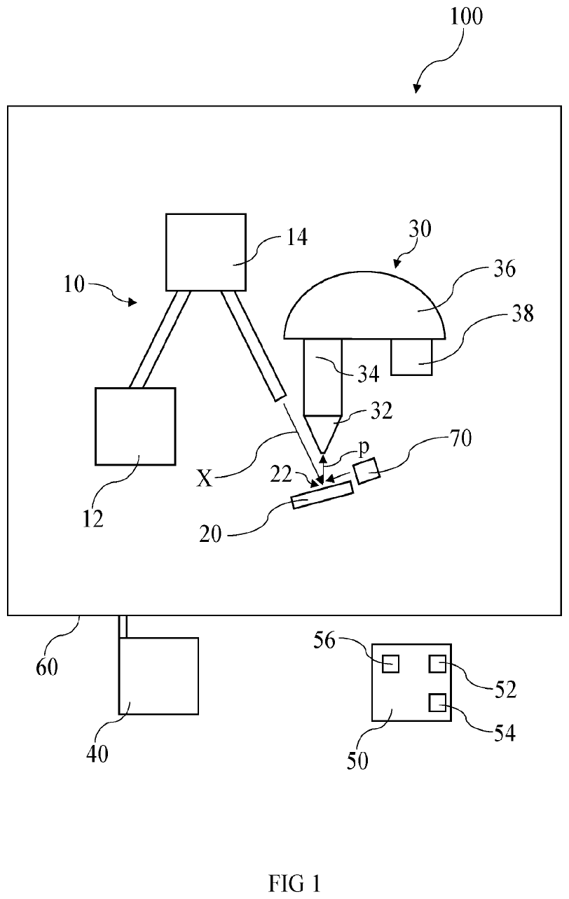

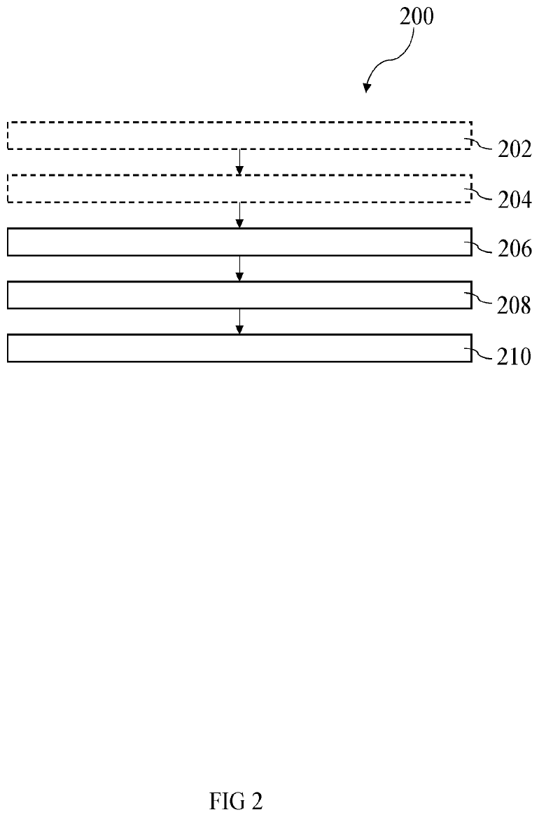

FIG. 1 schematically shows by way of example an embodiment of a photoelectron spectrometer 100 comprising a sample parameter value determination module 50 for determining a value for at least one of n sample parameters at a measuring point 22 of a sample 20 based on photoemission measurements, without destroying the sample 20 during the photoemission measurements, for example by sputtering with an ion gun. The photoelectron spectrometer 100 can be used to perform the method shown in FIG. 2 for determining a value for at least one of n sample parameters at a measuring point of a sample based on photoemission measurements, without destroying the sample during the photoemission measurements.

The photoelectron spectrometer 100 in this embodiment is an angle-resolving photoelectron spectrometer. The photoelectron spectrometer 100 contains an illumination device 10 for illuminating the sample 20 at the measuring point 22 with radiation in the form of X-rays X, each of different wavelengths, a detector device 30 for measuring photoelectrons p emitted by the sample 20, an ultra-high vacuum pump 40, the sample parameter value determination module 50 and a cavity in the form of a vacuum chamber 60. In addition, in this embodiment, a measuring device 70 for further measurements is arranged at the measuring point 22 of the sample 20. The measuring device 70 can, for example, perform ellipsometry measurements to determine values for sample parameters.

In this embodiment, the illumination device 10 contains an X-ray source 12 and a monochromator 14. In the X-ray source 12, X-rays X of different wavelengths are generated by firing electrons from an electron gun at different anode materials. The X-rays X are then monochromatized in the monochromator 14 and focused on the measuring point 22 of the sample. The monochromator 14 is configured to monochromatize X-rays X of different wavelengths and to focus them on the same measuring point 22. For this purpose, the monochromator 14 can, for example, comprise a plurality of reflective elements suitable for the corresponding wavelengths in a corresponding arrangement.

In this embodiment, the sample 20 is arranged on a sample holder (not shown). The sample holder is movable and tiltable. This allows rasterization of the sample 20. In addition, the sample 20 can be rasterized by being rasterized on the anode material by means of the electron gun of the X-ray source 12.

The detector device 30 contains a front cap electrode 32, a lens element array 34, an analyzer 36 in the form of a hemispherical analyzer and a detector 38 in the form of a CMOS detector. In other embodiments, for example, a different analyzer and/or a different detector may also be used.

The ultra-high vacuum pump 40 serves to create an ultra-high vacuum within the vacuum chamber 60.

The sample parameter value determination module 50 contains an interface 52 in the form of a transceiver, a processor 54 and a computer-readable medium 56 in the form of a memory 56. Alternatively or additionally, the interface may contain or be any other type of interface, such as a cable interface or a keyboard for a user to make inputs. The processor 54 is configured to execute a computer program product comprising instructions for the method shown in FIG. 2. The computer program product is stored on the computer-readable medium 56. Furthermore, in this embodiment, a sample parameter database is also stored in which predetermined values for the sample parameters are assigned to certain photoemission spectra. In other embodiments, the values for the sample parameters may also be associated with values for parameters derived from photoemission spectra.

During operation of the photoelectron spectrometer 100, monochromatized X-rays X of different wavelengths are focused on the measuring point 22 with an extension of 10 μm. In other embodiments, the measuring point can also comprise an extension of 100 μm or less, preferably 10 μm or less, or be between 10 μm and 100 μm, for example. The different wavelengths correspond to different excitation energies. The excitation energies can, for example, lie in the range from 1 keV to 10 keV. Since the X-rays X have different wavelengths, photoelectrons p are generated at different depths in the sample 20. The photoelectrons p emerge from the surface of the sample 20 and are received by the front cap electrode 32 of the detector device 30. The lens element array 34 guides the photoelectrons p into the analyzer 36, where they are resolved by kinetic energies. The photoelectrons p are detected in the detector 38. Photoemission spectra are then generated from the data measured by the detector 38. In this embodiment, photoemission spectra with different excitation energies and different emission angles are captured.

The photoemission spectra are obtained from the detector device via the interface 52 for further processing. In addition, the interface 52 obtains values for sample parameters obtained from other measurement methods, for example from the measuring device 70. In other embodiments, the parameter database may also be stored externally in relation to the sample parameter value determination module 50 and values for sample parameters may be obtained via the interface 52. In this embodiment, the values of the sample parameters from the sample parameter database are available to the sample parameter value determination module 50 via the computer-readable medium 56. In this embodiment, the sample parameter value determination module 50 receives values for at least one and up to n-1 sample parameters from the set of n sample parameters at the measuring point 22 of the sample 20 and a plurality of photoemission spectra captured with different excitation energies and emission angles from the measuring point 22 of the sample 20. The processor 54 determines the value for at least one sample parameter at the measuring point 22 of the sample 20 based on the values of the up to n-1 sample parameters and the photoemission spectra.

FIG. 2 shows a flow chart for an embodiment of a method 200 for determining a value for at least one of n sample parameters at a measuring point of a sample based on photoemission measurements without destroying the sample during the photoemission measurements. In this embodiment, the at least one sample parameter whose value is to be determined describes part of a sample structure, in particular a layer structure, at the measuring point of the sample. The method is particularly suitable for creating a depth profile for the sample without destroying the sample in the process.

In step 202, which is an optional step, a calibration sample may be provided for which values of a sample structure and a chemical composition are known. This can be used to calibrate measurement method parameters, especially instrumental parameters for the measurement.

In step 204, which is an optional step, values for the measurement method parameters can be determined using the calibration sample.

In step 206, values for at least one and up to n-1 sample parameters are obtained at the measuring point of the sample. The number of sample parameters n of the sample is a positive integer and depends on the sample. The values for the sample parameters can be obtained in different ways. In this embodiment, the values for the sample parameters are obtained from a combination of the following three ways:
entering a respective value for one or more of the sample parameters by a user,
measuring a respective value for one or more of the sample parameters by means of another measurement method, and
selecting or reading a respective value for one or more of the sample parameters from a sample parameter database comprising predetermined values for the sample parameters.

In other embodiments, the values may also only be obtained in one or two ways.

In step 208, a plurality of photoemission spectra captured with different excitation energies are obtained from the measuring point of the sample. In addition, photoemission spectra captured with different emission angles can also be obtained from the measuring point of the sample. The emission angles can, for example, span an interval of 60°. The measuring point can, for example, comprise an extension of 100 μm or less, preferably 10 μm or less. The excitation energies can lie in the range between 1 keV and 10 keV.

In step 210, the value for the at least one sample parameter at the measuring point of the sample is determined based on the values for the up to n-1 sample parameters and the photoemission spectra. In order to determine the value for the at least one sample parameter at the measuring point of the sample, peak areas in each of the photoemission spectra and/or the background in each of the photoemission spectra can be determined. The value for the at least one sample parameter at the measuring point of the sample can then be determined based on the peak areas, the backgrounds, or both. If optional steps 202 and 204 have been carried out, the value for the at least one sample parameter can additionally be determined based on the measurement method parameters determined using the calibration sample.

The invention relates to a photoelectron spectrometer comprising a sample value determination module and to a method for determining the value of at least one of n sample parameters at a measuring point of a sample based on photoemission measurements without destroying the sample during the photoemission measurements. Values for at least one and up to n-1 sample parameters from the set of n sample parameters are obtained at the measuring point of the sample and a plurality of photoemission spectra captured with different excitation energies are obtained from the measuring point of the sample. The value of the at least one sample parameter at the measuring point of the sample is determined based on the values of the up to n-1 sample parameters and the photoemission spectra.

1. A method for determining a value of at least one of n sample parameters at a measuring point of a sample based on photoemission measurements without destroying the sample, during the photoemission measurements, comprising:
obtaining values for at least one sample parameter and up to n-1 sample parameters from a set of n sample parameters at the measuring point of the sample,
obtaining a plurality of photoemission spectra captured with different excitation energies from the measuring point of the sample,
determining the value of the at least one sample parameter at the measuring point of the sample based on the values of the up to n-1 sample parameters and the photoemission spectra.

2. The method according to claim 1, wherein the at least one sample parameter whose value is to be determined describes a part of a sample structure at the measuring point of the sample.

3. The method according to claim 1, wherein the determination of the value of the at least one sample parameter comprises at least one of the steps of:
determining peak areas in each of the photoemission spectra,
determining a background in each of the photoemission spectra, and one of the steps of:
determining the value of the at least one sample parameter based on the peak areas of the photoemission spectra,
determining the value of the at least one sample parameter based on the backgrounds of the photoemission spectra, and
determining the value of the at least one sample parameter based on the peak areas and the backgrounds of the photoemission spectra.

4. The method according to claim 1, wherein obtaining the values for the at least one and up to n-1 sample parameters comprises one or more of the steps of:
entering a respective value for one or more of the sample parameters by a user,
measuring a respective value for one or more of the sample parameters by using another measuring method, and
selecting or reading a respective value for one or more of the sample parameters from a sample parameter database comprising predetermined values for the sample parameters.

5. The method according to claim 1, wherein the plurality of photoemission spectra captured with different excitation energies includes photoemission spectra captured from the measuring point of the sample with different emission angles.

6. The method according to claim 5, wherein the emission angles span an interval of 60°.

7. The method according to claim 1, wherein the measuring point of the sample has an extension of 100 μm or less.

8. The method according to claim 1, wherein the excitation energies are in a range from 1 keV to 10 keV.

9. The method according to claim 1, further comprising the steps of:
providing a calibration sample for which values of a sample structure and a chemical composition are known, and
determining values for measurement method parameters for determining the value of the at least one sample parameter by use of the calibration sample.

10. The method according to claim 9, further comprising the step of:
determining the value of the at least one sample parameter additionally based on the measurement method parameters determined by use of the calibration sample.

11. A sample parameter value determination module for determining a value of at least one of n sample parameters at a measuring point of a sample based on photoemission measurements without destroying the sample during the photoemission measurements, wherein the sample parameter value determination module comprises:
an interface for obtaining values for at least one sample parameter and up to n-1 sample parameters from a set of n sample parameters at the measuring point of the sample and a plurality of photoemission spectra captured with different excitation energies from the measuring point of the sample, and
a processor for determining the value of the at least one sample parameter at the measuring point of the sample based on the values of the up to n-1 sample parameters and the photoemission spectra.

12. A photoelectron spectrometer comprising a sample parameter value determination module according to claim 11 for determining the value of the at least one of the n sample parameters at the measuring point of the sample based on the photoemission measurements without destroying the sample during the photoemission measurements, wherein the photoelectron spectrometer comprises:
an illumination device for illuminating the sample at the measuring point with radiation of different wavelengths,
a detector device for measuring photoelectrons emitted by the sample,
wherein the photoelectron spectrometer is configured to capture a plurality of photoemission spectra with different excitation energies from the measuring point of the sample and to provide them to the sample parameter value determination module, and
wherein the sample parameter value determination module is configured to determine the value of the at least one sample parameter at the measuring point of the sample based on the up to n-1 sample parameters from the set of n sample parameters and the photoemission spectra obtained from the detector device.

13. The method according to claim 1, further comprising at least one of the following steps:
determining whether a layer of the sample has a predetermined layer thickness at the measuring point of the sample,
determining a degree of diffusivity of a layer boundary between adjacent layers,
determining an extent of a layer boundary between adjacent layers,
determining a reproducibility of a process for producing the sample,
testing an influence of the value of the at least one sample parameter on the function of the sample,
comparing different samples, and
finding formulas for producing samples.

14. A computer program product comprising instructions which, when the computer program product is executed by a processor, prompt the processor to carry out the method according to claim 1.

15. A computer-readable medium on which the computer program product according to claim 14 is stored.

16. The method according to claim 1, wherein the at least one sample parameter whose value is to be determined describes a part of a layer structure at the measuring point of the sample.

17. The method according to claim 1, wherein the measuring point of the sample has an extension of 10 μm or less.
